(19) United States
(12) Patent Application Publication
(10) Pub. No.: US 2025/0249888 A1
(43) Pub. Date: Aug. 7, 2025

(54) HYBRID VEHICLE SYSTEMS AND METHODS FOR CONTROLLING TORQUE AND DIAGNOSING TORQUE CONSTRAINTS

(71) Applicant: GM GLOBAL TECHNOLOGY OPERATIONS LLC, Detroit, MI (US)

(72) Inventors: J.Michael GWIDT, Brighton, MI (US); Yiran HU, Shelby Township, MI (US); Kee Y. KIM, Ann Arbor, MI (US); Krunal P. PATEL, South Lyon, MI (US); Sandhu Kurian KURIAN, Wixom, MI (US); Matthew Gabriel BUSH, West Bloomfield, MI (US); Daniel S. DIMOSKI, Bloomfield Hills, MI (US); Brandon Michael SMITSKY, Royal Oak, MI (US); Andrew M. ZETTEL, Port Moody (CA)

(21) Appl. No.: 18/432,642

(22) Filed: Feb. 5, 2024

(51) Int. Cl. B60W 20/50; B60K 6/52; B60W 10/06; B60W 10/08; B60W 10/119; B60W 20/10; G07C 5/08

(52) U.S. Cl. CPC B60W 20/50; B60K 6/52; B60W 10/06; B60W 10/08; B60W 10/119; B60W 20/10; G07C 5/0808; B60W 2510/0657; B60W 2510/083; B60W 2510/244; B60W 2520/10; B60W 2540/10; B60W 2720/403; B60Y 2200/92; B60Y 2400/82

(57) ABSTRACT

A system for determining a secondary axle torque of a hybrid vehicle is disclosed. The hybrid vehicle includes a primary axle driven by an engine and a secondary axle driven by an electric motor. The system includes one or more sensors configured to detect a driver torque request, and a control module in communication with the one or more sensors. The control module is configured to receive data from the one or more sensors indicative of the driver torque request, calculate a primary torque target for the primary axle based on an optimal engine torque, calculate a secondary torque target for the secondary axle based on the calculated primary torque target and the driver torque request, and generate a secondary torque command to drive the secondary axle based on the calculated secondary torque target and the driver torque request. Other example systems and methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to hybrid vehicle systems and methods for controlling torque and diagnosing torque constraints.

Electric vehicles (EVs) include battery electric vehicles (BEVs), hybrid vehicles, and/or fuel cell vehicles. Hybrid vehicles include one or more electric machines supplied by power stored in a battery system including one or more battery cells, modules and/or packs, and an internal combustion engine (ICE) that propel the vehicle. The electric machines operate as a motor to propel the vehicle and as a generator during regeneration. Hybrid vehicles tend to improve fuel economy and reduce vehicle emissions by using only the electric machines while the vehicle is idling or moving at low speeds.

Vehicles, such as hybrid vehicles are often equipped with catalytic converters to help reduce emissions of gases. Typical catalytic converters use catalysts, such as reduction catalysts and oxidation catalysts. When the engine is first started (e.g., a cold start condition), the catalytic converter is generally not effective in removing emissions in the exhaust until the catalytic converter reaches a desired operating temperature, which is sometimes referred to as a catalyst light-off temperature.

### SUMMARY

A vehicle system for determining a secondary axle torque of a hybrid vehicle is disclosed. The hybrid vehicle includes a primary axle driven by an engine and a secondary axle driven by an electric motor. The vehicle system includes one or more sensors configured to detect a driver torque request, and a control module in communication with the one or more sensors. The control module is configured to receive data from the one or more sensors indicative of the driver torque request, calculate a primary torque target for the primary axle based on an optimal engine torque, calculate a secondary torque target for the secondary axle based on the calculated primary torque target and the driver torque request, and generate a secondary torque command to drive the secondary axle based on the calculated secondary torque target and the driver torque request.

In other features, the control module is configured to determine a secondary torque limit for the secondary axle, and calculate the secondary torque target based on the calculated primary torque target, the driver torque request, and the secondary torque limit.

In other features, the control module is configured to set the secondary torque target to the secondary torque limit.

In other features, the control module is configured to receive a plurality of conditions associated with the hybrid vehicle and determine the secondary torque limit based on the received conditions.

In other features, the plurality of conditions include a state of charge of a battery associated with the electric motor, a speed of the hybrid vehicle, and a torque limit of the electric motor.

In other features, the control module is configured to generate a primary torque command to drive the primary axle.

In other features, the control module is configured to calculate the primary torque target for the primary axle based on the optimal engine torque and a condition associated with a transmission connected to the engine.

In other features, a hybrid vehicle includes the vehicle system.

A method for determining a secondary axle torque of a hybrid vehicle is disclosed. The hybrid vehicle includes a primary axle driven by an engine and a secondary axle driven by an electric motor. The method includes receiving data from one or more sensors indicative of a driver torque request, calculating a primary torque target for the primary axle based on an optimal engine torque, calculating a secondary torque target for the secondary axle based on the calculated primary torque target and the driver torque request, and generating a secondary torque command to drive the secondary axle based on the calculated secondary torque target and the driver torque request.

In other features, the method further includes determining a secondary torque limit for the secondary axle, and calculating the secondary torque target includes the secondary torque target for the secondary axle based on the calculated primary torque target, the driver torque request, and the secondary torque limit.

In other features, the method further includes setting the secondary torque target to the secondary torque limit.

In other features, the method further includes receiving a plurality of conditions associated with the hybrid vehicle, and determining the secondary torque limit includes determining the secondary torque limit based on the received conditions.

In other features, the plurality of conditions include a state of charge of a battery associated with the electric motor, a speed of the hybrid vehicle, and a torque limit of the electric motor.

In other features, the method further includes generating a primary torque command to drive the primary axle.

A method for diagnosing a reason for being unable to use an electric motor to drive a secondary axle of a hybrid vehicle while maintaining an engine for a primary axle of the hybrid vehicle at a defined torque range during catalyst light-off is disclosed. The method includes determining whether a secondary torque request for the secondary axle is constrained, in response to the secondary torque request being constrained, determining whether a fault condition is present, in response to determining the fault condition is not present, calculating an expected secondary torque limit for the secondary axle, determining whether an actual secondary torque limit for the secondary axle is greater than the expected secondary torque limit for the secondary axle, and in response to the actual secondary torque limit being less than the expected secondary torque limit, generating an emissions alert indicating catalyst light-off diagnostics to execute normally.

In other features, determining whether the secondary torque request is constrained includes determining whether the secondary torque request is different than a secondary torque target for the secondary axle for a defined set of reasons, and in response to the secondary torque request being different than the secondary torque target for a reason not found in the defined set of reasons, determining the secondary torque request is constrained due to a secondary torque limit.

In other features, the fault condition is a first fault condition, and the method further includes, in response to the secondary torque request being different than the secondary torque target for one of the defined set of reasons, determining whether a second fault condition is present.

In other features, the method further includes, in response to determining the second fault condition is not present, generating an emissions alert indicating catalyst light-off diagnostics is paused with an emission penalty.

In other features, the method further includes, in response to determining the second fault condition is present, generating the emissions alert indicating catalyst light-off diagnostics is paused without an emission penalty.

In other features, the method further includes, in response to determining the fault condition is present, generating an emissions alert indicating catalyst light-off diagnostics is paused without an emission penalty.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example of a hybrid vehicle including an internal combustion engine, an electric machine, and a control module for controlling secondary axle torque, according to the present disclosure;

FIG. 2 is a block diagram of an example hybrid vehicle system including a control module for controlling torque for a secondary axle and diagnosing reasons for being unable to drive the secondary axle during catalyst light-off events, according to the present disclosure;

FIG. 3 is a diagram showing primary and secondary axle torques over time, according to the present disclosure;

FIGS. 4-5 are flowcharts of example control processes for commanding a secondary axle torque of a hybrid vehicle with converter light-off control, according to the present disclosure; and

FIG. 6 is a flowchart of an example control process for diagnosing reasons for being unable to drive a secondary axle with an electric motor while maintaining an engine at a defined torque range during converter light-off control, according to the present disclosure.

In the drawings, reference numbers may be reused to identify similar and/or identical elements.

### DETAILED DESCRIPTION

A hybrid vehicle is often equipped with a catalytic converter to help reduce emissions of gases. In such examples, the hybrid vehicle includes an axle (e.g., a primary axle) driven by at least an engine and an axle (e.g., a secondary axle) driven by one or more electric motors. When the engine is first started (e.g., a cold start condition), the catalytic converter is generally ineffective until the catalytic converter reaches a converter or catalyst light-off (CLO) temperature. Typically, the engine is allowed to idle for a period of time so that the catalytic converter can its CLO temperature. If the vehicle is propelled with the engine before the catalytic converter is effective (e.g., before reaching the CLO temperature), emissions increase.

The hybrid vehicle systems and methods according to the present disclosure provide solutions for controlling a secondary torque for the secondary axle to maintain a primary torque for the primary axle within a desired range, as generally required by CLO control. In some cases, this allows the hybrid vehicle to utilize an EV mode to provide propulsion while maintaining the engine in an idle like condition until CLO is completed. For example, the solutions herein command the secondary torque when transitioning between EV and non-EV states to ensure that the drive quality targets and driver torque requests (e.g., a torque request from an actual driver or from an autonomous system, such as a fully or semi-autonomous system) are met while maintaining reduced levels of emissions until the engine is able to start normal operations (e.g., when the CLO is completed).

Additionally, in some cases, CLO operations may face conditions in which the electrically driven, secondary axle is unable to meet the drivers' torque request. This may result in the engine torque falling outside (e.g., exceeding) the desired range or boundary during CLO control. In various embodiments, it may be desirable for diagnostics of cold start emissions reduction to understand whether the secondary axle can provide enough torque to keep the engine torque in the desired range and if not, what is the reason for not doing so. Such information may be beneficial to CLO diagnostics in determining whether the diagnostics can be paused and if the function is meeting the required in-use rate.

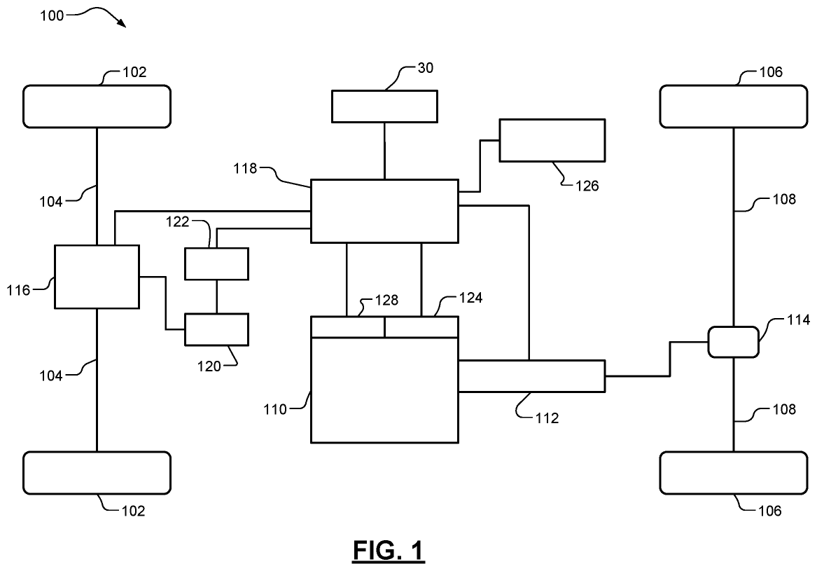

Referring now to FIG. 1, an example hybrid vehicle 100 is presented. As shown, the hybrid vehicle 100 includes wheels 102 connected to a secondary axle 104 and wheels 106 connected to a primary axle 108. In various embodiments, the wheels 102 may be front or back wheels and the wheels 106 may be back or front wheels. In the example of FIG. 1, the hybrid vehicle 100 also includes an engine 110 and a transmission 112 for supplying propulsion power via driveline components 114 to the wheels 106, and one or more electric machines 116 (acting as a motor) for supplying propulsion power to the wheels 102. In various embodiments, the engine 110 may be an internal combustion engine (ICE) or another suitable engine. Additionally, in some embodiments, an electrical variable transmission (EVT), a belt alternative system, etc. may be employed (e.g., as the transmission 112, etc.) with the engine 110 for driving the primary axle 108.

A control module 118 controls acceleration (e.g., torque output) of the engine 110 and/or the electric machine(s) 116 in response to driver inputs, vehicle speed, and/or other information. For example, the control module 118 may determine the amount of torque output to be delivered by the electric machine(s) 116 and/or the engine 110, as further explained herein. In such examples, the control module 118 may receive data from sensors 124 (e.g., speed, temperature, oxygen, etc.) and uses the data to control actuators 128 that adjust operation of the engine 110. The control module 118 may communicate with a transmission control module (not shown) that controls operation of the transmission 112. Additionally, the control module 118 may cause a battery 120 (e.g., a rechargeable energy storage system) to supply power via a power inverter (not shown) to the electric machine(s) 116 to vary the torque (power output) provided by the electric machine(s) 116. A battery management module (BMM) 122 monitors the battery 120 using one or more sensors and calculates a state of the charge (SOC) of the battery 120.

In various embodiments, the hybrid vehicle 100 also includes a catalytic converter 126 for reducing emissions as explained herein. In such examples, the catalytic converter 126 may include one or more sensors (e.g., temperature, oxygen, etc. sensors) providing data to the control module 118 regarding a status of the catalytic converter 126. For example, the data may be used to determine whether CLO is completed (e.g., the catalytic converter 126 reaches a CLO temperature). Before such time, the control module 118 may function in a CLO control, in which a secondary torque for the electrically driven, secondary axle 104 is commanded to attempt to allow a primary torque for the engine driven, primary axle 108 to remain within a desired range.

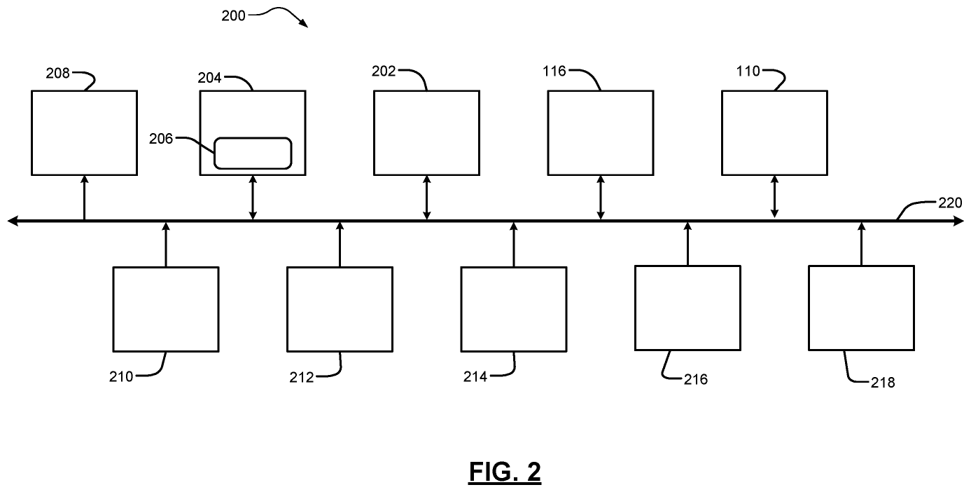

FIG. 2 depicts an example vehicle system 200 for controlling torque for the secondary axle 104 of the hybrid vehicle 100 of FIG. 1 and diagnosing reasons for being unable to drive the secondary axle 104 during CLO events. As shown in FIG. 2, the vehicle system 200 generally includes a control module 202, a memory circuit 204 storing one or more look-up tables 206, an alert module 208, and various sensors for detecting or sensing vehicle parameters. In various embodiments, the control module 202 may be similar to the control module 118 of FIG. 1. In the example of FIG. 2, the sensors may include, for example, a vehicle speed sensor 210, a catalyst sensor 212, one or more transmission sensors 214, one or more input sensors 216, and a battery sensor 218.

Although FIG. 2 illustrates the vehicle system 200 as including specific modules and/or sensors, it should be appreciated that the vehicle system 200 and/or other systems may include one or more other modules and/or sensors (e.g., having the same or different functionalities) if desired. Additionally, while the vehicle system 200 is shown as including multiple separate modules, any combination of the modules (e.g., the control module 202, the alert module 208, etc.) and/or the functionality thereof may be integrated into one or more modules.

In various embodiments, the modules and sensors of the vehicle system 200 may be in communication with each other and may share parameters via a network 220, such as a controller area network (CAN). In such examples, the parameters may be shared via one or more data buses of the network 220. As such, various parameters may be made available by a given module and/or sensor to other modules and/or sensors via the network 220.

With continued reference to FIG. 2, the control module 202 may receive data from one or more various sensors. For example, the control module 202 may receive data from the catalyst sensor 212 indicating a status of a catalytic converter (e.g., the catalytic converter 126 of FIG. 1). In such examples, the control module 202 may determine whether a CLO event is required to occur and if so, function in a CLO control, in which a secondary torque for the electrically driven, secondary axle 104 of FIG. 1 is commanded to attempt to allow a primary torque for the engine driven, primary axle 108 to remain within a desired range, as further explained below. Otherwise, if CLO control is not needed (e.g., a CLO event is not occurring), the control module 202 may control the engine 110 and the electric machine 116 according to a normal control.

Additionally, the control module 202 may receive data from the vehicle speed sensor 210. For example, the vehicle speed sensor 210 may sense a speed of the hybrid vehicle 100 and provide data indicative of the vehicle speed to the control module 202. Then, the control module 202 may determine whether the hybrid vehicle 100 is being driven (e.g., at a non-zero speed) or is not (e.g., idling). If the control module 202 determines that the hybrid vehicle 100 is at a non-zero speed (e.g., off idle or not idling), the control module 202 may implement the CLO control and rely on the electric machine 116 for needed torque, as further explained below. Otherwise, if the control module 202 determines that the hybrid vehicle 100 is idling (e.g., at zero speed), then the control module 202 may implement the CLO control and control the engine 110 with no assistance from the electric machine 116.

Further, the control module 202 receives data from the one or more input sensors 216 which detect a driver torque request. For example, a driver of the hybrid vehicle 100 may apply a force to a gas pedal indicating a desire to accelerate the hybrid vehicle 100. This action by the driver requires torque (power) or an increase in torque to be provided to one or both axles 104, 108 to accelerate the hybrid vehicle 100 in the manner requested by the driver. In such examples, the input sensor(s) 216 may detect this driver torque request and provide data to the control module 202 indicative of the driver torque request. In other examples, the driver torque request may come from an autonomous system (e.g., a fully autonomous system or a partial autonomous system). In such examples, the driver torque request may be received from and/or otherwise detected by the input sensor(s) 216.

In the example of FIG. 2, the control module 202 may initially determine a torque split between the primary and secondary axles 104, 108. In such examples, the torque split is determined in a manner to ensure that the sum of the primary and secondary torques meets the driver torque request.

In various embodiments, the control module 202 may calculate a primary torque target for the primary axle 108, which may be used as a desired torque for the primary axle 108. In such examples, the primary torque target may be calculated based on at least an optimal engine torque. For example, the control module 202 may access the optimal engine torque stored in the memory circuit 204. In such examples, the optimal engine torque may be specific to the hybrid vehicle 100 and set based on the particular characteristics and/or calibrations of the hybrid vehicle 100.

Additionally, in some examples, the primary torque target may be calculated based on the optimal engine torque and a condition associated with the transmission 112 connected to the engine 110. For example, the control module 202 may calculate the primary torque target based on the optimal engine torque and a known gear ratio. For example, the primary torque target may be determined by multiplying the optimal engine torque by the gear ratio (e.g., engine to axle). In some examples, the control module 202 may take in account other transmission conditions, such as a transmission status and/or a transmission clutch load torque. In such examples, the transmission status and/or a transmission clutch load torque may be provided by the transmission sensor(s) 214.

Then, the control module 202 may calculate a secondary torque target for the secondary axle 104. In such examples, the secondary torque target may be the remaining torque (after taking into account the primary torque target) required to fulfil the driver torque request received from the input sensor(s) 216. In other words, the secondary torque target may represent the torque required to meet the requested driver torque while maintaining the ICE optimal torque for CLO control. As such, the secondary torque target may be calculated based on the primary torque target and the driver torque request received from the input sensor(s) 216. For example, the control module 202 may determine the secondary torque target by subtracting the primary torque target from the driver torque request.

In various embodiments, various conditions may constrain the secondary torque target. In such examples, the secondary torque target may be limited to a maximum value. As such, the control module 202 may determine a secondary torque limit for the secondary axle 104 and then determine the secondary torque target based on the secondary torque limit. In some examples, the secondary torque limit may represent a not to exceed torque for the secondary axle 104. For example, the control module 202 may set the secondary torque target to the secondary torque limit if the secondary torque target would otherwise exceed the secondary torque limit.

The control module 202 may determine the secondary torque limit based on one or more conditions associated with the hybrid vehicle 100. For example, the control module 202 may receive data indicative of a speed of the hybrid vehicle 100 from the vehicle speed sensor 210, a SOC of the battery 120 from the battery sensor 218 (e.g., a sensor associated with the BMM 122 of FIG. 1), etc. In various embodiments, the control module 202 receives or otherwise accesses an engine speed from one of the look-up tables 206 based on the vehicle speed. Additionally, the control module 202 receives or accesses a torque limit of the electric machine 116 from one of the look-up tables 206. Any one of more of these received conditions associated with the hybrid vehicle 100 may be used when determining the secondary torque limit.

Additionally, in some embodiments, other criteria may be taken into account when determining the secondary torque limit. For example, the control module 202 may additionally and/or alternatively determine the secondary torque limit based on constraints associated with vehicle dynamics, constraints associated with drive quality (e.g., rate of change limits, etc.), etc.

Then, the control module 202 generates a secondary torque command to drive the secondary axle 104 based on, for example, the calculated secondary torque target and the driver torque request. For example, the control module 202 may shape the secondary torque target for the secondary axle 104. In such examples, the control module 202 may shape the secondary torque target based on various inputs, such as the driver torque request received from the input sensor(s) 216, a transmission clutch load torque received from the transmission sensor(s) 214, a target acceleration response map (tARM), etc. Then, the control module 202 may generate the secondary torque command based on the shaped secondary torque target.

The electric machine 116 may then drive the secondary axle 104 based on the generated secondary torque command. For example, the control module 202 may control the electric machine 116 based on the secondary torque command to drive the secondary axle 104. Alternatively, the control module 202 may transmit a control signal with the secondary torque command to another control module for the electric machine 116.

Additionally, the control module 202 generates a primary torque command to drive the primary axle 108. For example, the control module 202 may determine a final primary torque request based on the driver torque request, the calculated secondary torque target, and any limits placed thereon. For instance, the final primary torque request may correspond to the primary torque target if the secondary torque target is able to fulfil the driver torque request. This may be true regardless of the secondary torque limit (if applicable), operational constraints, etc. Alternatively, if the secondary torque target is unable to fulfil the driver torque request (e.g., due to the secondary torque limit, operational constraints, etc.), the final primary torque request may exceed the primary torque target. Then, the control module 202 may generate the primary torque command based on the final primary torque request.

The engine 110 may then drive the primary axle 108 based on the generated primary torque command. For example, the control module 202 may control the engine 110 and the transmission 112 based on the primary torque command to drive the primary axle 108. Alternatively, the control module 202 may transmit a control signal with the primary torque command to another control module for the engine 110 and the transmission 112.

In various embodiments, the control module 202 may diagnose a reason for being unable to use the electric machine 116 to drive the secondary axle 104 while maintaining the engine 110 for the primary axle 108 at a defined torque range (e.g., at the primary torque target) during CLO. In such examples, the control module 202 may generally determine and categorize the reason and then use the reason to assist in real-time CLO diagnostics, as further explained below.

For example, the control module 202 may generally determine whether a secondary torque request for the secondary axle 104 is constrained. In such examples, the secondary torque request may be based on the driver torque request, the calculated secondary torque target, and any limits placed thereon. If the final primary torque request is within the defined torque range (e.g., within the primary torque target), the control module 202 may determine that no constraints exist, and CLO diagnostics can execute normally. In some examples, the control module 202 may generate an emissions alert indicating such.

If, however, the final primary torque request is outside the defined torque range (e.g., exceeds the primary torque target), the secondary torque request is necessarily different than the secondary torque target and constrained. In such examples, the control module 202 may isolate various causes related to drive quality constraints and vehicle dynamics. For instance, the control module 202 may determine if the secondary torque request is different than the secondary torque target for a defined set of reasons, such as an override relating to drive quality constraints (e.g., shaping, wide open acceleration pedal, etc.) or vehicle dynamics. If so, the control module 202 may determine whether a fault condition (e.g., a communication fault condition) is present and caused the difference. In such examples, the control module 202 identifies the system as being fault constrained and generates an emissions alert indicating CLO diagnostics is paused without an emission penalty (e.g., no in-use rate penalty). If, however, the control module 202 determines that the difference between the secondary torque request and the secondary torque target was not caused by a fault condition (e.g., a fault condition is not present), the control module 202 identifies the system as being operationally constrained and generates another emissions alert indicating CLO diagnostics is paused with an emission penalty (e.g., the lack of CLO operation counts against the in-use rate). In various embodiments, the emissions alerts herein may be provided to the alert module 208 (e.g., a display device, an audible alarm, etc.).

In other examples when the secondary torque request is constrained, the control module 202 may isolate causes related to a capacity or limit of the secondary axle 104 that are resulting from known faults in the secondary axle propulsion system, such as battery or motor faults. For example, the control module 202 may determine whether an active fault condition is present. In such examples, the active fault condition may relate to any condition that affects the secondary axle's ability to deliver torque. For example, the active fault condition may be associated with the electric machine 116, the secondary axle propulsion system (e.g., a drive unit), the battery 120, a control system for the electric machine 116, the secondary axle propulsion system, the battery 120, etc. If so, the control module 202 determines that the system is fault constrained and generates the emissions alert indicating CLO diagnostics is paused without an emission penalty (e.g., no in-use rate penalty), as explained above.

If, however, no active fault condition is present, the control module 202 may isolate causes related to a capacity or limit of the secondary axle 104 where the driver torque request is too high to be met by even a reasonably capable secondary axle 104. In such examples, the control module 202 may calculate an expected secondary torque limit for the secondary axle 104. For instance, the control module 202 may determine the expected secondary torque limit (e.g., a reasonably capable secondary axle range) based on maximum values of conditions, such as battery temperature, motor temperature and SOC where EV driving is allowed. Then, the control module 202 may determine whether the actual secondary torque limit for the secondary axle 104 is greater than the expected secondary torque limit. If so, the control module 202 determines that the system is operationally constrained and generates the emissions alert indicating CLO diagnostics is paused with an emission penalty (e.g., the lack of CLO operation counts against the in-use rate). If, however, the actual secondary torque limit for the secondary axle 104 is less than the expected secondary torque limit, the control module 202 may determine that no constraints exist, and generate an emissions alert indicating CLO diagnostics can execute normally.

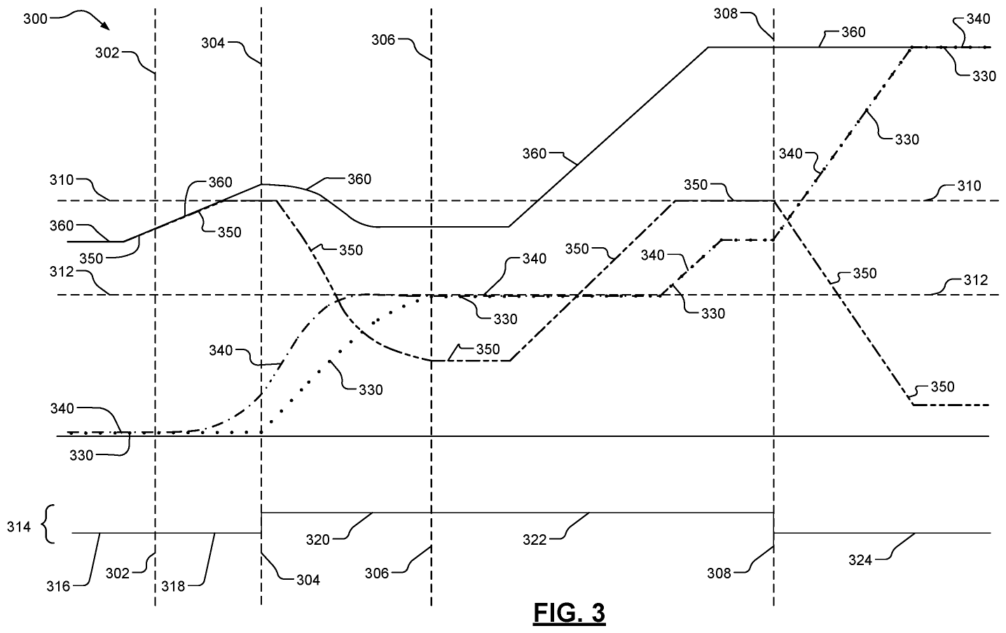

FIG. 3 depicts an example timing diagram 300 for controlling torque for the secondary axle 104 of the hybrid vehicle 100 of FIG. 1 while attempting to maintain the engine 110 for the primary axle 108 at a defined torque range during CLO. As shown in FIG. 3, the timing diagram 300 includes four vertical dashed lines representing points in time 302, 304, 306, 308, and two horizontal dashed lines representing a secondary torque limit 310 for the secondary axle 104 and a primary CLO torque target 312 for the primary axle 108. In FIG. 3, a transmission clutch load torque 330 is represented by a line having a dot-dot-dot configuration, a primary torque command 340 is represented by a line having a dash-dot-dash configuration, a secondary torque command 350 is represented by a line having a long dash-short dash-short dash-long dash configuration, a driver torque request 360 is represented by a solid line.

Additionally, the timing diagram 300 includes a CLO status 314 having a state 316 where the engine is off, a state 318 where the engine is starting and the primary clutch is open, a state 320 where the primary clutch is engaging and CLO is active, a state 322 where the primary clutch is engage and CLO is active, and a state 324 where CLO is completed. As shown, the state 316 falls before time 302, the state 318 falls between times 302, 304, the state 320 falls between times 304, 306, the state 322 falls between times 306, 308, and the state 324 falls after time 308.

As shown, the transmission clutch load torque 330 and the primary torque command 340 generally track together. For example, initially the transmission clutch load torque 330 and the primary torque command 340 are at or near zero during the state 316 and then begin to gradually increase during the state 318. Additionally, initially the secondary torque command 350 and the driver torque request 360 generally track together and gradually increase towards the secondary torque limit 310 during the state 318. As shown, the driver torque request 360 exceeds the secondary torque limit 310 while the secondary torque command 350 levels off at the secondary torque limit 310 during the state 318. At this time, the secondary axle 104 is saturated as the driver torque request 360 has exceeded the secondary torque limit 310. When the transmission clutch load torque 330 and the primary torque command 340 are at or near zero, the engine 110 is off and EV is driving. When the transmission clutch load torque 330 and the primary torque command 340 begin to increase, the engine 110 is started to provide torque required to meet the driver torque request 360. In such examples, the engine 110 is started because the electric machine 116 cannot provide the requested torque. In other examples, the engine 110 may start as the electric machine 116 is approaching its limit.

Then, during the state 320, the transmission clutch load torque 330 and the primary torque command 340 gradually increase to the primary CLO torque target 312. In such examples, the primary torque command 340 causes the primary clutch load torque 330 to increase. For example, a system primary torque command may direct the transmission control module to close the clutch. As the transmission control module closes the clutch, the primary clutch load torque 330 reflects the torque increase until the clutch is fully closed. During the state 320, the secondary torque command 350 begins to fall from the secondary torque limit 310 to maintain total driver request as the engine torque is brought up to exactly meet the driver torque request 360.

Next, during the state 322, the driver torque request 360 again increases and then levels off before time 308. During this time, the secondary torque command 350 begins to increase again and levels off at the secondary torque limit 310 to meet the increased driver torque request. At this time, the primary torque command 340 is maintained at the primary CLO torque target 312. Then, once the secondary torque command 350 levels off at the secondary torque limit 310 (e.g., reaches its limit), the transmission clutch load torque 330 and the primary torque command 340 begin to increase beyond the primary CLO torque target 312 to allow the propulsion system to meet the overall driver torque request 360.

Then, at the state 324, the CLO is deemed completed. During this time, the primary torque command 340 and the transmission clutch load torque 330 increase to the driver torque request 360 and the secondary torque command 350 falls to a torque target which charges the battery 120. As such, once the CLO is completed, the engine 110 and the electric machine 116 begin their normal operation without consideration for the primary CLO torque target 312 and the secondary torque limit 310.

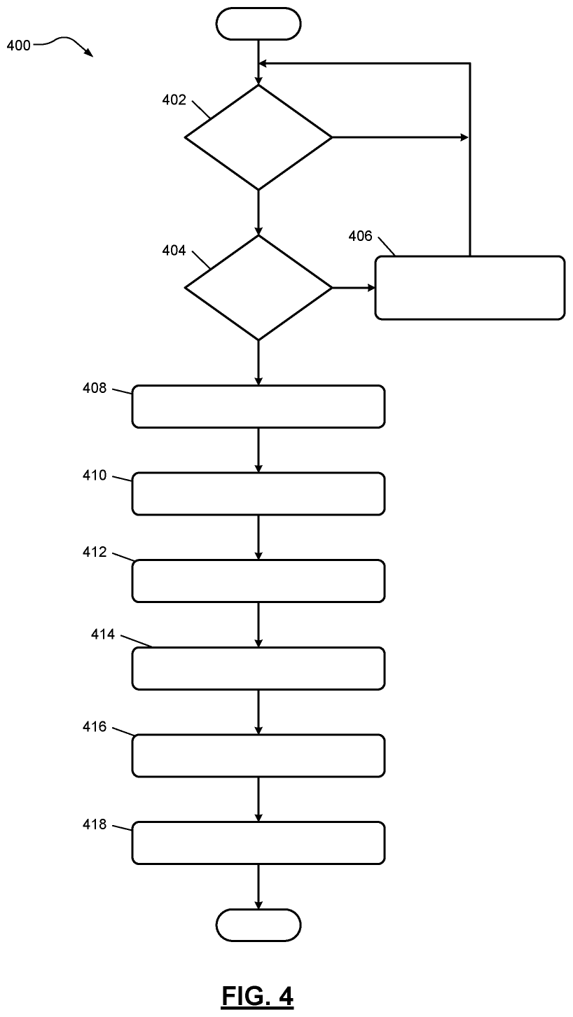

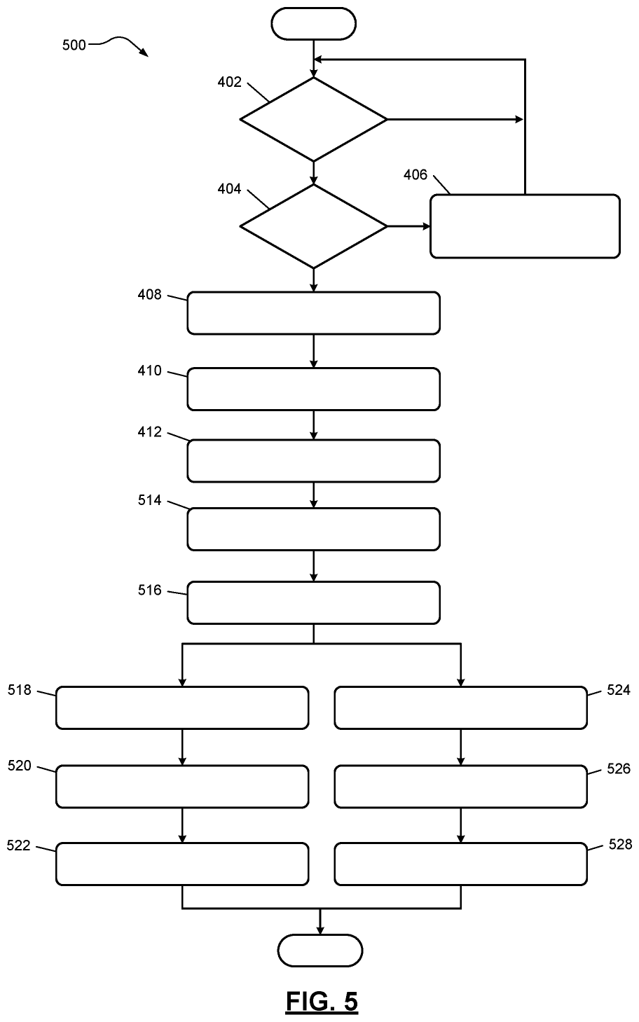

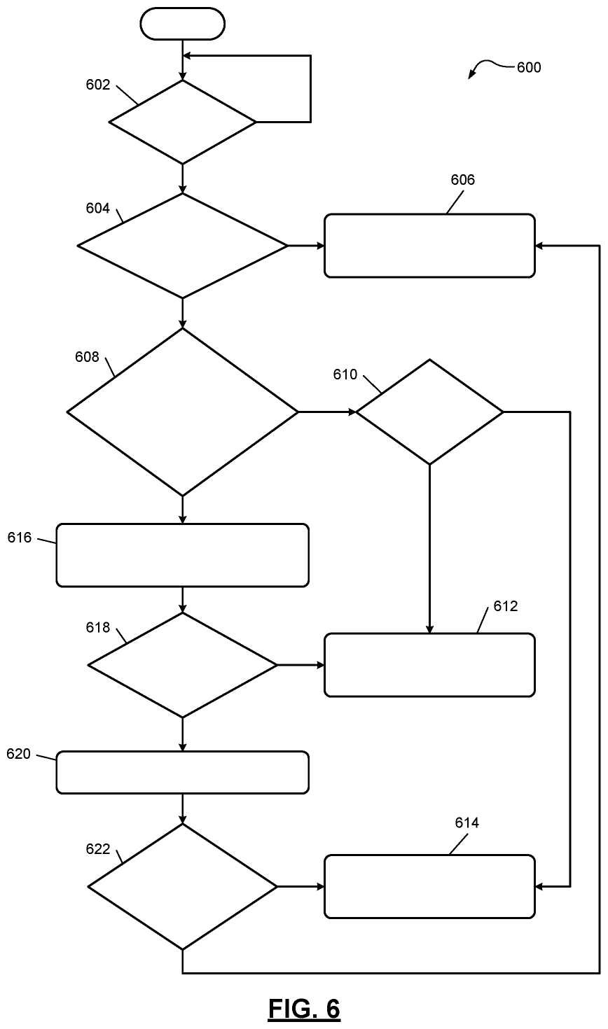

FIGS. 4-6 illustrate example control processes 400, 500, 600 employable by the vehicle system 200 of FIG. 2 in connection with the hybrid vehicle 100 of FIG. 1. Specifically, and as further explained below, the control processes 400, 500 of FIGS. 4-5 relate to commanding a secondary axle torque of the hybrid vehicle 100 and the control process 600 of FIG. 6 relates to diagnosing reasons for being unable to use the electric machine 116 (acting a motor) to drive the secondary axle 104 of the hybrid vehicle 100 while maintaining the engine 110 at a defined torque range during CLO. Although the example control processes 400, 500, 600 are described in relation to the vehicle system 200 of FIG. 2 and the hybrid vehicle 100 of FIG. 1, any one of the control processes 400, 500, 600 may be employable by another suitable system and/or in another suitable hybrid vehicle.

In FIG. 4, the control process 400 begins at 402 where the control module 202 determines whether a CLO status is true. For example, and as explained above, the control module 202 may receive data from the catalyst sensor 212 indicating a status of the catalytic converter 126 of FIG. 1. In such examples, the control module 202 may determine whether a CLO event is occurring or is active. If yes (or true), control proceeds to 404. Otherwise, control returns to 402.

At 404, the control module 202 determines whether the hybrid vehicle 100 is idling. In such examples, the control module 202 may determine whether the hybrid vehicle 100 is being driven (e.g., at a non-zero speed) or is not (e.g., idling) based on data from the vehicle speed sensor 210. If the hybrid vehicle 100 is idling at 404, control proceeds to 406 where the control module 202 implements idle CLO control (e.g., a conventional CLO control) to control the engine 110 with no assistance from the electric machine 116. If, however, the hybrid vehicle 100 is not idling at 404, control proceeds to 408, 410.

At 408, the control module 202 receives a driver torque request. For example, and as explained above, the input sensor(s) 216 may detect a driver torque request (e.g., based on actions of the driver) and provide data to the control module 202 indicative of the driver torque request. At 410, the control module 202 receives an optimal engine torque which may be stored in the memory circuit 204. Control then proceeds to 412.

At 412, the control module 202 calculates a primary torque target for the primary axle 108. The primary torque target may be used as a desired torque for the primary axle 108. In such examples, the primary torque target may be calculated based on the optimal engine torque, a gear ratio, a transmission status, a transmission clutch load torque, etc. as explained above. Control then proceeds to 414.

At 414, the control module 202 calculates a secondary torque target for the secondary axle 104 based on, for example, the primary torque target and the driver torque request. For example, and as explained above, the secondary torque target may be the remaining torque required to fulfil the driver torque request after taking into account the primary torque target. In other words, the secondary torque target may be calculated by subtracting the primary torque target from the driver torque request. Control then proceeds to 416.

At 416, the control module 202 generates a secondary torque command to drive the secondary axle 104 based on, for example, the secondary torque target and the driver torque request. For instance, and as explained above, the control module 202 may shape the secondary torque target for the secondary axle 104 based on various inputs, such as the driver torque request, a transmission clutch load torque, a tARM, etc. Then, the control module 202 may generate the secondary torque command based on the shaped secondary torque target. Control then proceeds to 418.

At 418, the control module 202 generates and transmits a control signal to drive the secondary axle 104. For example, the control module 202 may generate the control signal with the secondary torque command and then transmit the control signal to the electric machine 116 (or another control module). The electric machine 116 may then drive the secondary axle 104 based on the control signal. Control then ends as shown in FIG. 4.

The control process 500 of FIG. 5 is similar to the control process 400 of FIG. 4, but with additional and/or alternative control features. For example, the control process 500 of FIG. 5 includes the initial steps 402, 404, 406, 408, 410, 412 as explained above relative to the control process 400 of FIG. 4. Then, control proceeds 514.

At 514, the control module 202 determines a secondary torque limit for the secondary axle 104. In some examples, the secondary torque limit may represent a not to exceed torque for the secondary axle 104. In various embodiments, the secondary torque limit may be determined based on one or more conditions associated with the hybrid vehicle 100. For example, and as explained above, the control module 202 may rely on a vehicle speed, an engine speed, a SOC of the battery 120, a torque limit of the electric machine 116, vehicle dynamic constraints, drive quality constraints, etc.

In various embodiments, the control module 202 may provide a compliance and limitation status according to the secondary torque limit. In such examples, the control module 202 may calculate the compliance and limitation status based on system limits. This information may be stored in the memory circuit 204 or otherwise made available by the control module 202 for diagnostic procedures.

Control then proceeds 516, where the control module 202 calculates a secondary torque target for the secondary axle 104. In such examples, the secondary torque target may be determined based on, for example, the primary torque target, the driver torque request, and the secondary torque limit, as explained herein. Control then proceeds to 518, 524.

At 518, the control module 202 generates a primary torque request based on, for example, the driver torque request, the secondary torque target, and any limits placed thereon. For example, and as explained above, the primary torque request may correspond to the primary torque target if the secondary torque target is able to fulfil the driver torque request, regardless of the secondary torque limit (if applicable), operational constraints, etc. Alternatively, if the secondary torque target is unable to fulfil the driver torque request (e.g., due to the secondary torque limit, operational constraints, etc.), the final primary torque request may exceed the primary torque target. Control then proceeds to 520, 522.

At 520, the control module 202 generates a primary torque command to drive the primary axle 108 based on the primary torque request. Then, at 522, the control module 202 generates and transmits a control signal with the primary torque command to drive the primary axle 108. In such examples, the engine 110 may then drive the primary axle 108 based on the control signal.

At 524, the control module 202 generates a secondary torque request based on, for example, the driver torque request, the secondary torque target, and any limits placed thereon. Control then proceeds to 526, 528.

The control module 202 generates a secondary torque command to drive the secondary axle 104 based on the secondary torque request at 526, and generates and transmits a control signal with the secondary torque command at 528. In such examples, the electric machine 116 may then drive the secondary axle 104 based on the control signal, as explained herein. Control then ends as shown in FIG. 5.

In FIG. 6, the control process 600 begins at 602 where the control module 202 determines whether a CLO status is active. For example, and as explained above, the control module 202 may determine whether CLO control is initiated. If no, control returns to 602. If yes, control proceeds to 604.

At 604, the control module 202 determines whether a primary torque request is within a defined torque range. In various embodiments, the control module 202 may generate the primary torque request as explained above, and then compare the primary torque request to threshold(s) associated with the defined torque range. If the primary torque request falls within the defined torque range, control proceeds to 606 where the control module 202 determines that no constraints exist, and CLO diagnostics can execute normally. In various embodiments, a notification (e.g., a generated emissions alert) indicative of this determination may be provided to the alert module 208 if desired.

If, however, the primary torque request falls outside the defined torque range (e.g., exceeds the primary torque target), a secondary torque request is necessarily different than a secondary torque target and therefore constrained. In such examples, control proceeds to 608 where the control module 202 determines if the secondary torque command is different than secondary torque target for a defined set of reasons, such as an override relating to drive quality constraints or vehicle dynamics. In this information may be provided with the compliance and limitation status explained above.

If the control module 202 determines that the difference is due to one of the defined reasons, control proceeds to 610. At 610, the control module 202 determines whether a fault condition is present and caused the difference. For example, and as explained above, the difference may be caused by a communication fault condition associated with the system. If so, control proceeds 612, where the control module 202 identifies the system as being fault constrained and generates an emissions alert indicating CLO diagnostics is paused without an emission penalty (e.g., no in-use rate penalty). In such embodiments, the emissions alert may be provided to the alert module 208 if desired.

If, however, the difference is not caused by a fault condition, control proceeds 614. At 614, the control module 202 identifies the system as being operationally constrained and generates an emissions alert indicating CLO diagnostics is paused with an emission penalty (e.g., the lack of CLO operation counts against the in-use rate). In such embodiments, this emissions alert may be provided to the alert module 208 if desired.

If the control module 202 determines that the difference is due a reason not found in the defined set of reasons at 608, control proceeds to 616, 618. At 616, the control module 202 identifies that the secondary torque request is constrained due to a secondary torque limit. At 618, the control module 202 determines whether an active fault condition is present. For example, and as explained above, the active fault condition may relate to the battery 120, the electric machine 116, etc. If yes at 618, control proceeds 612. Otherwise, control proceeds 620, 622.

At 620, the control module 202 calculates an expected secondary torque limit for the secondary axle 104. For example, and as explained above, the expected secondary torque limit may be calculated based on maximum values of conditions, such as battery temperature, motor temperature and SOC where EV driving is allowed. Then, at 622, the control module 202 determines whether the actual secondary torque limit for the secondary axle 104 is greater than the expected secondary torque limit. For example, the control module 202 may compare the previously determined secondary torque limit and the expected secondary torque limit. If the actual secondary torque limit is greater than the expected secondary torque limit, control proceeds 614. Otherwise, control proceeds to 606.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for determining a secondary axle torque of a hybrid vehicle, the hybrid vehicle including a primary axle driven by an engine and a secondary axle driven by an electric motor, the vehicle system comprising:
one or more sensors configured to detect a driver torque request; and
a control module in communication with the one or more sensors, the control module configured to:
receive data from the one or more sensors indicative of the driver torque request;
calculate a primary torque target for the primary axle based on an optimal engine torque;
calculate a secondary torque target for the secondary axle based on the calculated primary torque target and the driver torque request; and
generate a secondary torque command to drive the secondary axle based on the calculated secondary torque target and the driver torque request.

2. The vehicle system of claim 1, wherein the control module is configured to:
determine a secondary torque limit for the secondary axle; and
calculate the secondary torque target based on the calculated primary torque target, the driver torque request, and the secondary torque limit.

3. The vehicle system of claim 2, wherein the control module is configured to set the secondary torque target to the secondary torque limit.

4. The vehicle system of claim 2, wherein the control module is configured to receive a plurality of conditions associated with the hybrid vehicle and determine the secondary torque limit based on the received conditions.

5. The vehicle system of claim 4, wherein the plurality of conditions include a state of charge of a battery associated with the electric motor, a speed of the hybrid vehicle, and a torque limit of the electric motor.

6. The vehicle system of claim 1, wherein the control module is configured to generate a primary torque command to drive the primary axle.

7. The vehicle system of claim 1, wherein the control module is configured to calculate the primary torque target for the primary axle based on the optimal engine torque and a condition associated with a transmission connected to the engine.

8. A hybrid vehicle comprising the vehicle system of claim 1.

9. A method for determining a secondary axle torque of a hybrid vehicle, the hybrid vehicle including a primary axle driven by an engine and a secondary axle driven by an electric motor, the method comprising:
receiving data from one or more sensors indicative of a driver torque request;
calculating a primary torque target for the primary axle based on an optimal engine torque;
calculating a secondary torque target for the secondary axle based on the calculated primary torque target and the driver torque request; and
generating a secondary torque command to drive the secondary axle based on the calculated secondary torque target and the driver torque request.

10. The method of claim 9, wherein:
the method further comprises determining a secondary torque limit for the secondary axle; and
calculating the secondary torque target includes the secondary torque target for the secondary axle based on the calculated primary torque target, the driver torque request, and the secondary torque limit.

11. The method of claim 10, further comprising setting the secondary torque target to the secondary torque limit.

12. The method of claim 10, wherein:
the method further comprises receiving a plurality of conditions associated with the hybrid vehicle; and
determining the secondary torque limit includes determining the secondary torque limit based on the received conditions.

13. The method of claim 12, wherein the plurality of conditions include a state of charge of a battery associated with the electric motor, a speed of the hybrid vehicle, and a torque limit of the electric motor.

14. The method of claim 9, further comprising generating a primary torque command to drive the primary axle.

15. A method for diagnosing a reason for being unable to use an electric motor to drive a secondary axle of a hybrid vehicle while maintaining an engine for a primary axle of the hybrid vehicle at a defined torque range during catalyst light-off (CLO), the method comprising:
determining whether a secondary torque request for the secondary axle is constrained;
in response to the secondary torque request being constrained, determining whether a fault condition is present;
in response to determining the fault condition is not present, calculating an expected secondary torque limit for the secondary axle;
determining whether an actual secondary torque limit for the secondary axle is greater than the expected secondary torque limit for the secondary axle; and
in response to the actual secondary torque limit being less than the expected secondary torque limit, generating an emissions alert indicating CLO diagnostics to execute normally.

16. The method of claim 15, wherein determining whether the secondary torque request is constrained includes:
determining whether the secondary torque request is different than a secondary torque target for the secondary axle for a defined set of reasons; and
in response to the secondary torque request being different than the secondary torque target for a reason not found in the defined set of reasons, determining the secondary torque request is constrained due to a secondary torque limit.

17. The method of claim 16, wherein:
the fault condition is a first fault condition; and
the method further comprises, in response to the secondary torque request being different than the secondary torque target for one of the defined set of reasons, determining whether a second fault condition is present.

18. The method of claim 17, further comprising, in response to determining the second fault condition is not present, generating an emissions alert indicating CLO diagnostics is paused with an emission penalty.

19. The method of claim 17, further comprising, in response to determining the second fault condition is present, generating the emissions alert indicating CLO diagnostics is paused without an emission penalty.

20. The method of claim 15, further comprising, in response to determining the fault condition is present, generating an emissions alert indicating CLO diagnostics is paused without an emission penalty.
